(19) United States
(12) Patent Application Publication
(10) Pub. No.: US 2006/0107575 A1
(43) Pub. Date: May 25, 2006

(54) Wet floor caution sign

(76) Inventor: Joe H. Ashley, Hattiesburg, MS (US)

Correspondence Address: LITMAN LAW OFFICES, LTD, PO BOX 15035, CRYSTAL CITY STATION, ARLINGTON, VA, 22215, US

(21) Appl. No.: 11/263,956

(22) Filed: Nov. 2, 2005

Related U.S. Application Data
(60) Provisional application No. 60/624,552, filed on Nov. 4, 2004.

(51) Int. Cl. G09F 7/00

(52) U.S. Cl. 40/612

(57) ABSTRACT

The wet floor caution sign is either a cone-shaped or paneled sign. The surface of the caution sign has illuminated indicia displayed on it so that pedestrians may quickly become aware of the unsafe condition of the floor. The sign has indicia in the form of either a graphic image or lettering is illuminated by a light source(s). The light source(s) may include circuitry causing the light source(s) to flash.

### CROSS-REFERENCE TO RELATED APPLICATION

This application claims the benefit of U.S. Provisional Patent Application Ser. No. 60/624,552, filed Nov. 4, 2004.

### BACKGROUND OF THE INVENTION

1. Field of the Invention

The present invention relates to signs, and particularly to a wet floor caution sign with indicia in the form of flashing lights.

2. Description of the Related Art

Slippery floor surfaces are quite hazardous to passing pedestrians who cannot see or do not notice the impending danger. In order to provide some level of protection for the pedestrians, caution signs are often displayed in areas that may cause the pedestrians harm. These warning signs are typically portable signs placed on the floor surface to warn of a hazard. While these signs are helpful, they are often ignored by passing pedestrians because these signs have become so prevalent.

Some caution signs have been built using audible devices or other such devices to help alert the nearby pedestrians more effectively to the hazard. Some devices are patterned after beacons, with a light atop a cone. Others exhibit a constant light from a face of the sign, either at all times, or constantly in response to a signal received from a motion detector. However, these devices do not clearly draw notice to the actual indicia to which the pedestrians need to pay attention, but often merely draw attention to the sign itself.

Accordingly, there is a need for a warning sign that brings attention to the actual warning indicia of which passing pedestrians need to be aware by providing illuminated indicia to focus attention on the indicia itself. Thus, a wet floor caution sign solving the aforementioned problems is desired.

### SUMMARY OF THE INVENTION

The present invention is a wet floor caution sign, which is designed to warn pedestrians against unsafe floor conditions, such as a wet or waxed floor. The wet floor caution sign has illuminated indicia on it so that pedestrians may quickly become aware of the unsafe condition of the floor. In some embodiments, the indicia may be set to flash, so that pedestrians may be more inclined to notice the caution sign.

The wet floor caution sign may either have a cone-shaped frame or a frame made from two panels pivotally coupled together, or any other form of portable signage. The sign is designed to rest on a floor having a condition that poses a danger or presents a safety hazard, such as a wet or newly waxed surface. Indicia in the form of an image and/or lettering are disposed on the surface of either the cone or the panels. The image, the lettering, or both is illuminated by a light source. The light source may be, for example, light-emitting diodes or a fiber optic tube, cable or fiber. The light source may be set to illuminate in a flashing manner by appropriate electronic circuitry. Pedestrians passing the sign will therefore be more inclined to notice the flashing warning indicia indicating unsafe floor conditions.

These and other features of the present invention will become readily apparent upon further review of the following specification and drawings.

### BRIEF DESCRIPTION OF THE DRAWINGS

FIG. 1 is a perspective view of a wet floor caution sign according to a first embodiment of the present invention with an image of a fallen person illuminated.

FIG. 2 is a perspective view of a wet floor caution sign according to a second embodiment of the present invention with lettering indicia illuminated.

FIG. 3 is a perspective view of a wet floor caution sign according to a third embodiment of the present invention with an image of a fallen person illuminated.

FIG. 4 is a perspective view of a wet floor caution sign according to a fourth embodiment of the present invention with lettering indicia illuminated.

FIG. 5 is a block diagram of the electronic circuitry within the wet floor caution sign of the present invention.

Similar reference characters denote corresponding features consistently throughout the attached drawings.

### DETAILED DESCRIPTION OF THE PREFERRED EMBODIMENTS

The present invention comprises various embodiments of a wet floor caution sign, configured to warn pedestrians against unsafe floor conditions, such as a wet or waxed floor. The wet floor caution sign has illuminated indicia on it so that pedestrians may quickly become aware of the unsafe condition of the floor.

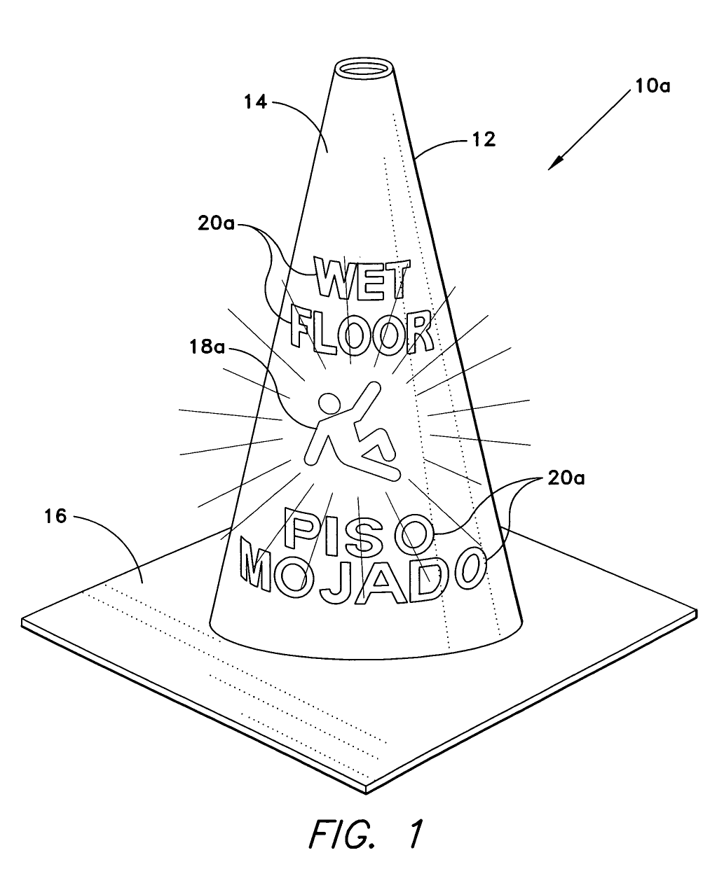

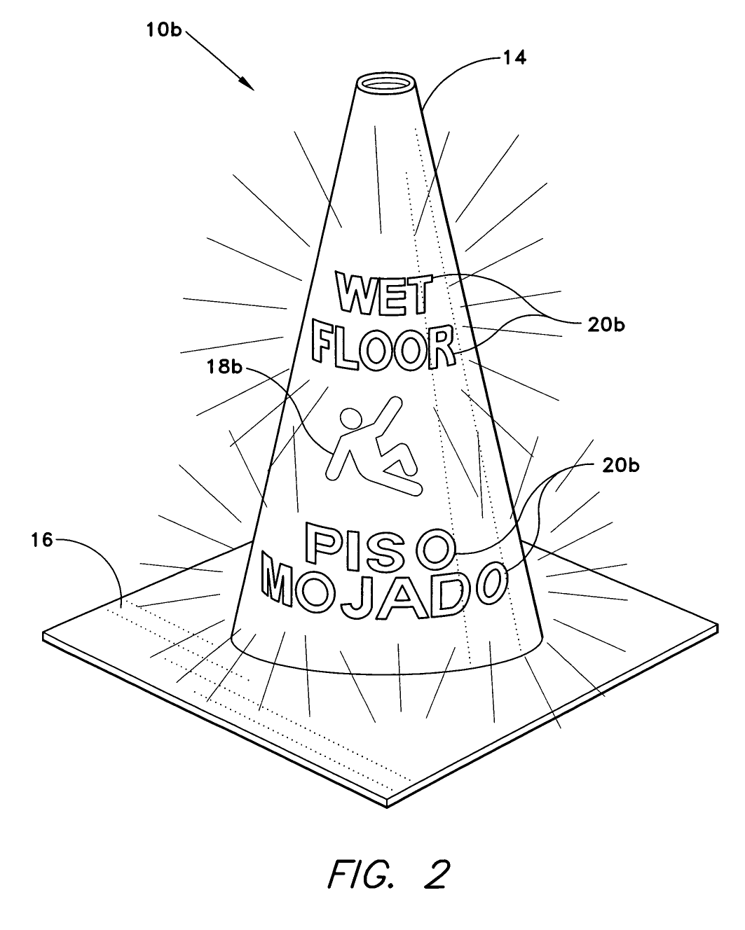

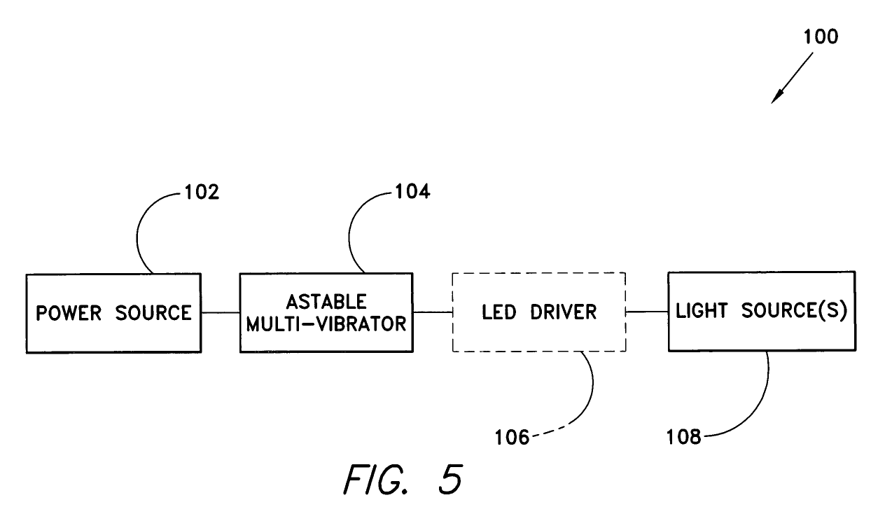

FIGS. 1 and 2 show perspective views of first and second embodiments of a wet floor caution sign, designated as 10a and 10b, respectively. These two embodiments are similar, the wet floor caution signs 10a and 10b including a frame 12 having a cone 14 and a base portion 16 integrally connected to the cone 14. The base portion 16 is adapted to rest upon a floor surface. Indicia in the form of an image, such as a figure of a person 18a and 18b, and lettering 20a and 20b are disposed on the surface of the cone 14. Either the figure of the person 18a (as shown in FIG. 1) or the lettering 20b (as shown in FIG. 2) are illuminated by a light source, as described below with reference to FIG. 5. The indicia 18a, 18b, 20a and 20b may be alphanumeric, an image, a symbol, or any other known type of indicia. The light source may either be light-emitting diodes (LEDs) or fiber optic lights. The light source may be set to illuminate in a flashing manner, so that pedestrians passing the sign 10 will be more inclined to notice the warning indicia 18a, 18b, 20a and 20b indicating unsafe floor conditions.

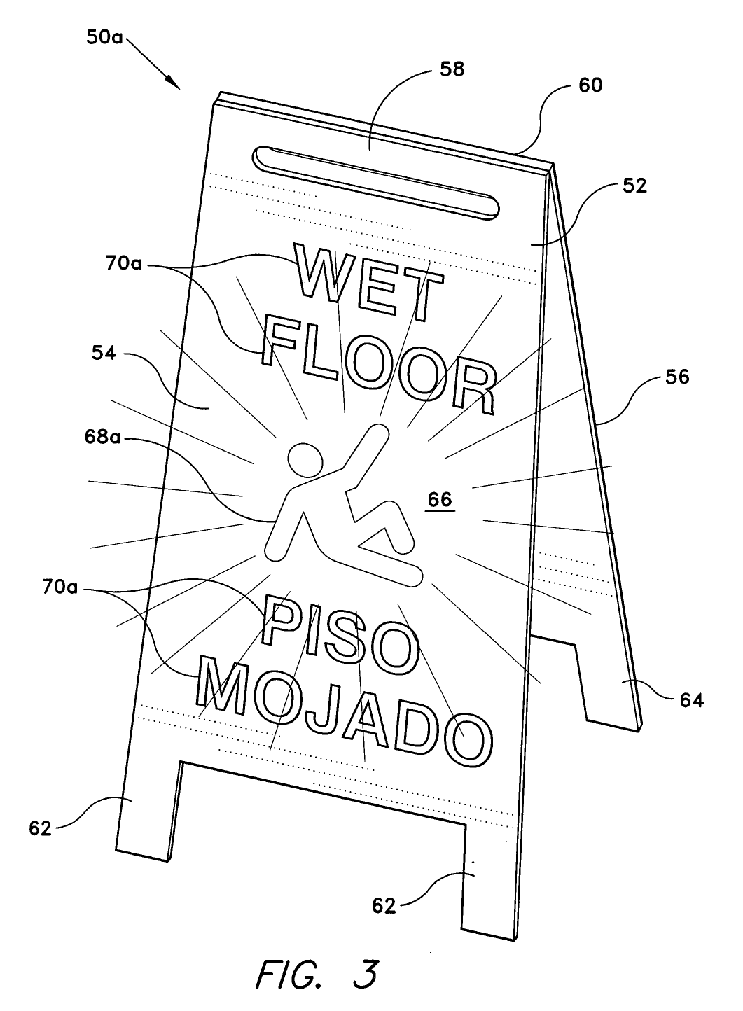

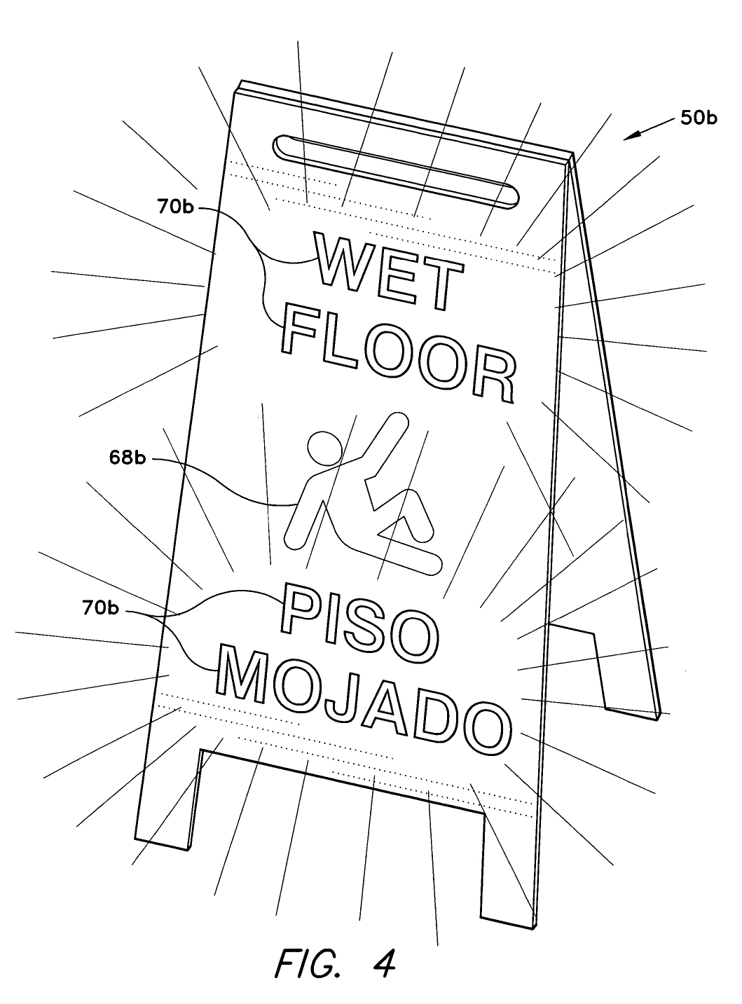

FIGS. 3 and 4 show perspective views of third and fourth embodiments of the wet floor caution sign, designated as 50a and 50b, respectively. The caution signs 50a and 50b are similar, having a frame 52 made from a first 54 and a second 56 panel. The first panel 54 has a top edge 58 and a pair of legs 62. The second panel 56 also has a top edge 60 and a pair of legs 64. The top edges 58 and 60 of the support panels 54 and 56 are pivotally coupled together so that the sign 50 is foldable. The legs 62 and 64 rest upon the floor surface and support the caution sign. Each panel has an outer display surface 66 that allows for the display of warning indicia.

In FIGS. 3 and 4, indicia in the form of a figure of a fallen person 68a and 68b and in the form of lettering 70a and 70b are shown on the outer display surface 66 of the first panel 54. In FIG. 3, the figure of the person 68a is illuminated by a light source, which may be set to flash. In FIG. 4, the lettering 70a is illuminated by a light source, which may be set to flash.

Turning now to FIG. 5, a block diagram of an exemplary electronic circuit 100 powering one or more light sources that illuminate either the graphic indicia depicting the fallen person 18a and 68a in the embodiments of FIGS. 1 and 3, or the literal indicia 20b and 70b in FIGS. 2 and 4, respectively, is shown. The circuitry 100 is located either within the cone 14 or on the back surface of one of the panels 54 and 56. The illumination or light source(s) 108 may be provided by a plurality of light-emitting diodes (LEDs), or display LED integrated circuits, with an appropriate circuit to cause the LEDs to flash, or by a fiber optic member, such as fiber optic cable, fiber or tubing that may be on constantly or set to flash.

In the example shown in FIG. 5, a power source 102 is connected to an astable multivibrator 104 that sets the frequency at which light source 108 flashes. The astable multivibrator may be, e.g., a 555 IC circuit configured to operate in astable multivibrator mode. Such a circuit is well known in the electrical art, and will not be described further. Alternatively, any other circuit known in the art for flashing LEDs or fiber optic elements may be substituted for the astable multivibrator circuit 104, e.g., a microprocessor, microcontroller, oscillator circuit, etc.

The power source 102 may be a rechargeable or non-rechargeable battery or any other known power source. The astable multivibrator 104 is electrically connected to the light source(s) 108, allowing for the light source(s) 108 to operate in a flashing manner as desired. When the light source(s) 108 are light-emitting diodes or a display LED integrated circuit (IC), an LED driver 106 may be interconnected between the astable multivibrator 102 and the light source(s) 108 to provide the voltage and current to drive the LED light source(s) 108.

When the light source(s) is a fiber optic element, the element may be end fed by a halogen light source, high intensity LED, or other source capable of illuminating the cable, fiber(s), or tubing throughout its length. When the fiber optic element is illuminated constantly, the astable multivibrator circuit 104 is unnecessary. When either the LED or fiber optic light source 108 is operated in flashing mode, additional circuitry may be added to illuminate the sign in flashing mode for a predetermined time interval that may be triggered, e.g., by a motion detector.

It will be understood that although the cone-shaped and the folding panel caution sign embodiments have been described as having either the literals or the fallen man image illuminated, either embodiment may be provided so that both the literal indicia and the graphic indicia are capable of illumination either simultaneously, or as a user-selectable option through an appropriate switch. It will be further understood that the particular message depicted by the literal indicia and by the graphic indicia are not critical, and may vary from the specific examples depicted in the drawings consistently with the scope of the invention as claimed.

It is to be understood that the present invention is not limited to the embodiments described above, but encompasses any and all embodiments within the scope of the following claims.

I claim:

1. A floor sign, comprising:
a frame adapted for marking a slippery floor surface, said frame having warning indicia appearing thereon; and
means for illuminating at least a portion of said warning indicia.

2. The floor sign according to claim 1, wherein said frame comprises a cone and a base integrally connected to the cone.

3. The floor sign according to claim 1, wherein said frame comprises a first panel having a top edge and a pair of legs opposite the top edge, and a second panel having a top edge and a pair of legs opposite the top edge, wherein the first and second panels are pivotally joined together at the top edges, whereby the sign is foldable about the pivotally connected top edges.

4. The floor sign according to claim 1, wherein said warning indicia comprises a graphical image.

5. The floor sign according to claim 1, wherein said warning indicia comprises lettering.

6. The floor sign according to claim 1, wherein said warning indicia comprises a graphical image and lettering.

7. The floor sign according to claim 1, wherein said means for illuminating comprises a fiber optic lighting element.

8. The floor sign according to claim 1, wherein said means for illuminating comprises a plurality of light-emitting diodes and means for flashing the light-emitting diodes.

9. The floor sign according to claim 1, wherein said means for illuminating comprises means for optionally selecting between steady illumination and flashing illumination.

10. The floor sign according to claim 1, wherein said means for illuminating is selected from the group consisting of an astable multivibrator circuit, a microprocessor-based circuit, a microcontroller-based circuit, and an oscillator circuit.

11. The floor sign according to claim 1, wherein said means for illuminating comprises a plurality of light-emitting diodes, an LED driver electrically connected to the LED driver, and means for flashing the LEDS on and off.

12. The floor sign according to claim 1, wherein said means for illuminating further comprises a motion detector for triggering a flashing mode for a predetermined time interval.

13. The floor sign according to claim 1, wherein said means for illuminating is disposed within an interior portion of said frame.
